(19) United States
(12) Patent Application Publication
(10) Pub. No.: US 2009/0144475 A1
(43) Pub. Date: Jun. 4, 2009

(54) ELECTRONIC DEVICE AND CONTROL METHOD THEREOF

(75) Inventor: Seung-hun Park, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/254,262

(22) Filed: Oct. 20, 2008

(30) Foreign Application Priority Data
Nov. 30, 2007 (KR) 2007-123997

(51) Int. Cl. G06F 13/00

(52) U.S. Cl. 710/301

(57) ABSTRACT

An electronic device includes a plurality of memories inserted in at least one memory slot provided on a board; and a controller provided on the board to perform data communication with the plurality of memories, and to adjust an intensity of a current for data communication with a memory selected from the plurality of memories based on a distance between the controller and the memory slot in which the selected memory is inserted.

### CROSS-REFERENCE TO RELATED APPLICATION

This application claims the benefit of Korean Application No. 2007-123997, filed in the Korean Intellectual Property Office on Nov. 30, 2007 the disclosure of which is incorporated herein by reference.

### BACKGROUND OF THE INVENTION

1. Field of the Invention

Aspects of the present invention relate to an electronic device and a control method thereof, and more particularly to an electronic device and a control method thereof, which can perform data communication between a plurality of memories and a controller.

2. Description of the Related Art

An electronic device such as an image forming device, a portable terminal, or the like includes a board to process data and control operations thereof. The board includes a controller to process the data and control general operations of the electronic device, and a plurality of memories, such as a random access memory (RAM), to provide a storage needed for control of the controller.

A plurality of memory slots in which such memories are inserted is provided on the board. The memory slots are arranged at a predetermined distance from the controller. The controller performs data communication with the memory through the memory slot. A signal transmitted to the plurality of memories may be distorted since the signal is reflected depending on routing distances between the memory slots in which the memories are inserted.

FIGS. 1A and 1B show waveforms of signals, i.e., voltages transmitted to the memories inserted in the plurality of memory slots. The memory slot shown in FIG. 1A is closer to the controller than the memory slot shown in FIG. 1B. A signal from the memory closer to the controller is distorted by reflection of the signal due to a stub for connecting the memory slots. As shown in FIG. 1A, if the intensity of the current is low, such as in the case of a low driver strength 10, the electronic device may malfunction due to errors such as a data reading error, a delayed signal input, etc. with regard to data at a predetermined part 30. As shown in FIG. 1A, if the intensity of current is high, such as in the case of a high driver strength 10, there is a low possibility of errors in reading the data or the signal because of satisfying both Vth(min) and Vth(max) even though the voltage waveform is distorted.

On the other hand, as shown in FIG. 1B, a signal from the memory distant from the controller is hardly distorted regardless of whether intensity of current is low (i.e., low driver strength 40) or high (i.e., high driver strength 50) because the signal is not significantly affected by the reflection of the signal. However, a large width of a voltage swing may arise in the case of the high driver strength 50. The large width of the voltage swing generates heat and increases the temperature of the board, and causes emissions (hereinafter, referred to as “electromagnetic interference (EMI)”), so that the electronic device is likely to malfunction. To maintain the quality of the signal stably, the signals input from the controller to the memory may have different optimum intensities of current according to the distances between the memory slot and the controller, i.e., depending on the routing distances.

The electronic device does not generally use all of the memories provided on the board at the same time, but rather uses a memory region needed for system operation under control of the controller. For example, the electronic device may use a 1:4 daisy chain structure of one controller and four memories, in data transmission. Such four memories may be inserted as a predetermined memory module in one memory slot.

Accordingly, it is possible to determine the optimum intensity of current depending on the routing distance between the controller and the memory slot in which the memory being in practical use for the data transmission among the plurality of memories is inserted. However, the conventional electronic device uses constant intensity of current to perform the data communication between the controller and the memory without considering the optimum intensity of current corresponding to the memory, thereby causing a malfunction due to distorted waveform or radiated emission.

### SUMMARY OF THE INVENTION

Aspects of the present invention provide an electronic device which controls intensity of current for data communication between a memory and a controller to be adjusted according to routing distances between the memory and the controller to thereby stably maintain the quality of a signal, and a control method thereof.

Additional aspects of the present invention provide an electronic device that is prevented from malfunctioning due to increased temperature of a board, radiated emission (EMI), etc., caused by a large width of voltage swing, and a control method thereof.

According to an aspect of the present invention, an electronic device is provided. The electronic device comprises a plurality of memories inserted in memory slots provided on a board; and a controller provided on the board to perform data communication with the plurality of memories and to adjust an intensity of a current for data communication with a memory selected from the plurality of memories based on a distance between the controller and a memory slot in which the selected memory is inserted.

According to another aspect of the present invention, the controller increases the intensity of the current when performing the data communication with the memory slot in such a manner that the intensity of the current is higher than that for performing the data communication with a more distant memory slot.

According to another aspect of the present invention, the controller decreases the intensity of the current when performing the data communication with the memory slot in such a manner that the intensity of the current is lower than that for performing the data communication with a closer memory slot.

According to another aspect of the present invention, the controller transmits a chip selection signal to at least one of the plurality of memories.

According to another aspect of the present invention, the electronic device further comprises a storage unit to store data about intensities of currents corresponding to the plurality of memories, wherein the controller reads the previously stored data corresponding to the selected memory and adjusts the intensity of current for the data communication based on the read data.

According to another aspect of the present invention, a method of controlling an electronic device comprising a plurality of memories to be inserted in memory slots provided on a board, and a controller to perform data communication with the plurality of memories through the memory slots, is provided. The method comprises selecting at least one of the plurality of memories; and adjusting an intensity of a current for data communication with the selected memory based on a distance from the memory slot in which the selected memory is inserted to the controller.

According to another aspect of the present invention, the adjusting of the intensity of the current comprises increasing the intensity of the current when performing the data communication with the memory slot in such a manner that the intensity of the current is higher than that for performing the data communication with a more distant memory slot.

According to another aspect of the present invention, the adjusting of the intensity of the current may comprise decreasing the intensity of the current when performing the data communication the distant memory slot among the plural memory slots in such a manner that the intensity of current is lower than that for performing the data communication with a closer memory slot.

According to another aspect of the present invention, the selecting of at least one of the plurality of memories comprises transmitting a chip selection signal to a desired memory.

According to another aspect of the present invention, the method further comprises storing data about intensities of currents corresponding to the plurality of memories, wherein the adjusting of the intensity of the current comprises reading the previously stored data corresponding to the selected memory, and adjusting the intensity of current for the data communication based on the read data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIGS. 1A and 1B show waveforms of signals transmitted to memories inserted in a plurality of memory slots;

FIG. 2 is a block diagram of an electronic device according to an embodiment of the present invention;

FIG. 3 illustrates a board with the memories and the memory slots;

FIG. 4 illustrates data communication structure between a controller and the memories according to an embodiment of the present invention;

FIGS. 5A and 5B show intensities of data signals depending on selected memories according to an embodiment of the present invention; and

FIGS. 6 and 7 are flowcharts of a control method of the electronic device according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

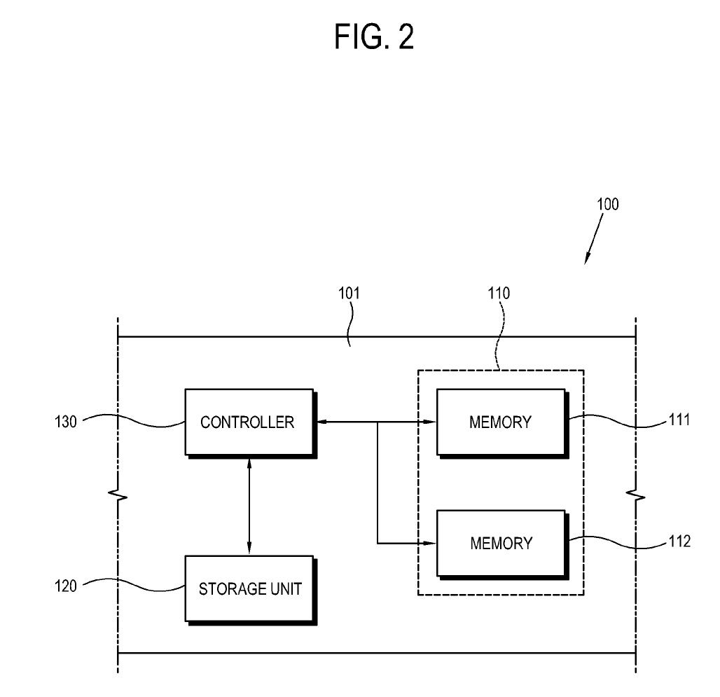

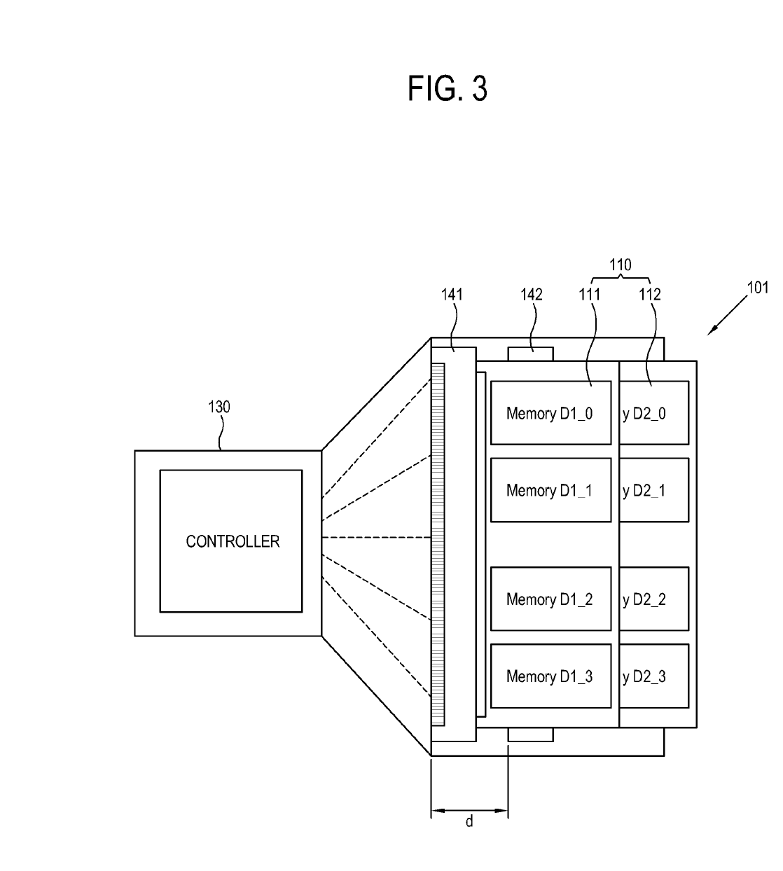

FIG. 2 shows an electronic device 100 according to an embodiment of the present invention, and FIG. 3 shows a board 101 with memories 111, 112 and memory slots 141, 142. A copying machine, a multi-function peripheral, a laser printer, an inkjet printer, or other image forming devices or terminals may be used as the electronic device 100.

As shown in FIG. 2, the electronic device 100 includes the board 101, a memory unit 110 having the plurality of memories 111 and 112, a storage unit 120, and a controller 130. According to other aspects of the present invention, the electronic device 100 may include additional and/or different units. Similarly, the functionality of one or more of the above units may be integrated into a single component. The board 101 is provided with a plurality of memory slots 141, 142 (shown in FIG. 3). The controller 130 uses the memory slots 141, 142 to perform data communication with the plurality of memories 111 and 112 inserted in the memory slots 141 and 142, respectively. The plurality of memories 111, 112 has a distance difference d depending on which memory slots they are inserted.

The memory unit 110 includes the plurality of memories 111, 112 provided as a predetermined memory module and inserted in the plurality of memory slots 141, 142. The plurality of memories 111, 112 may each include a dynamic random access memory (DRAM) or static random access memory (SRAM). Each memory 111, 112 may be provided as a dual-in-line memory module (DIMM) and performs the data communication of 1:4 or 1:16 with the controller 130. Here, a signal used in the data communication may include a data signal, a command signal, etc. Other types of memories may also be employed in the memory unit 110.

The storage unit 120 stores data about the intensity of current corresponding to the plurality of memories 111, 112. The storage unit 120 may be provided as a chip integrated with the controller 130, i.e., as an element of the controller 130.

The controller 130 is provided on the board 101 (as shown in FIG. 3), and transmits a selection signal to at least one of the plurality of memories 111, 112 so as to select the memory, thereby performing the data communication with the selected memory. The controller 130 can adjust the intensity of current for the data communication according to a distance between the controller 130 and the memory slot 141, 142 in which the memory selected among the plurality of memories 111, 112 is inserted, in other words, can adjust the intensity of current according to a routing distance. The controller 130 previously stores data about intensities of current properly corresponding to the plurality of memories 111, 112, and reads the previously stored data about the intensity of current corresponding to the memory selected by the chip selection signal, thereby using the corresponding intensity of current to perform the data communication with the memory.

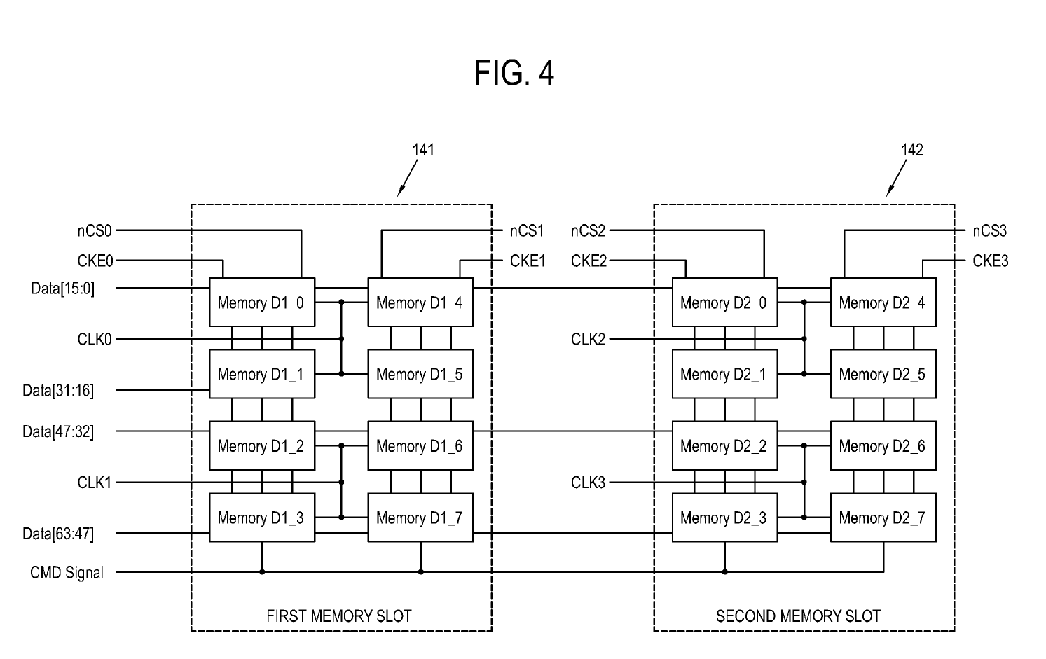

FIG. 4 shows a data communication structure between a controller and the memories according to an embodiment of the present invention. The memories Memory D1_0 through D1_7, and Memory D2_0 through Memory D2_7, inserted in the plurality of memory slots 141, 142, are each provided as a dual-in-line memory module (DIMM). The controller 130 uses an 1:4 or 1:16 daisy chain structure to perform the data communication with the plurality of memories Memory D1_0 through D1_7 and Memory D2_0 through Memory D2_7.

The controller 130 applies a chip selection signal nCS0 and nCS1 to the memories Memory D1_0 through D1_7, and selects the memories Memory D1_0 through D1_7 inserted in a first memory slot 141 among the memories Memory D1_0 through D1_7 and Memory D2_0 through D2_7. The controller 130 uses the current having intensity corresponding to the selected memories Memory D1_0 through D1_7 so as to perform the data communication with the corresponding memories Memory D1_0 through D1_7. Data about the intensity of current corresponding to the selected memory is previously stored in the storage unit 120.

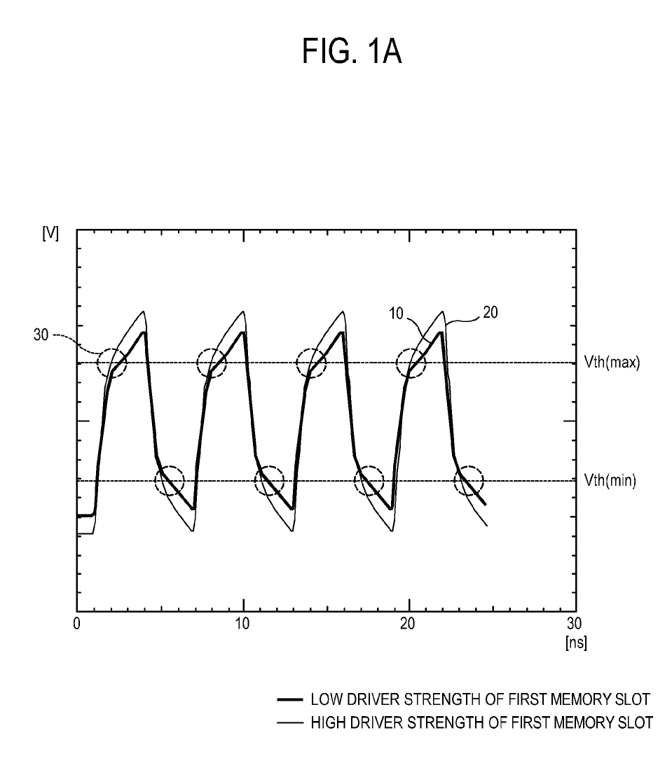

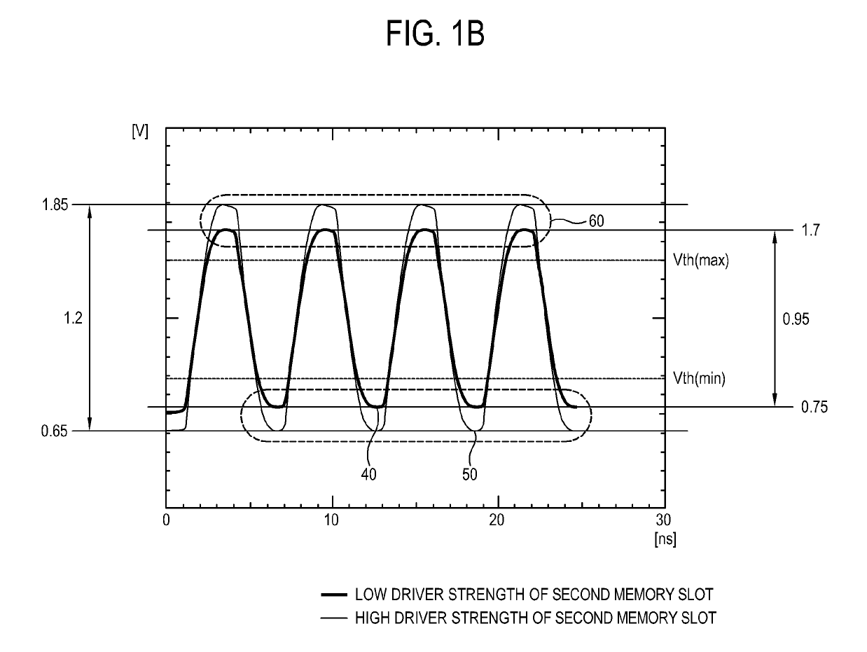

For example, the first memory slot 141 in which the memories Memory D1_0 through D1_7 selected by the chip selection signal nCS0 and nCS1 are inserted is placed closer to the controller 130 (as shown in FIG. 3). Thus, a signal input to the memories Memory D1_0 through D1_7 has a distorted waveform as shown in FIG. 1A because the signal is reflected from the stub connecting the memory slots of the daisy chain structure. Accordingly, to perform stable data communication, the memories Memory D1_0 through D1_7 close to the controller 130 should use high intensity of current, i.e., high driver strength. The electronic device 100 is affected only by data input to the memories Memory D1_0 through D1_7 regardless of any signal input to the memories Memory D2_0 through D2_7.

Likewise, the controller 130 applies a chip selection signal nCS2 and nCS3 to the memories Memory D2_0 through D2_7, and selects the memories Memory D2_0 through D2_7 inserted in a second memory slot 142. The controller 130 uses the current having intensity corresponding to the selected memories Memory D2_0 through D2_7 so as to perform the data communication with the corresponding memories Memory D2_0 through D2_7.

For example, the second memory slot 142 in which the memories Memory D2_0 through D2_7 selected by the chip selection signal nCS2 and nCS3 are inserted is placed far from the controller 130 (as shown in FIG. 3), so that the second memory slot 142 is not significantly affected by the reflection of the signal from the stub. Accordingly, the waveform of the signal is stable, as shown in FIG. 1B, regardless of the intensity of current.

However, if the high driver strength is used in the data communication, a large width of voltage swing may occur. The large width of the voltage swing not only consumes the current surplus to requirements, but also increases the temperature of the board, causes EMI, and other problems, thereby increasing the probability of a malfunction. The intensity of current (driver strength) is adjusted according to the memory slots 141, 142 so as not to cause the excessive large width of the voltage swing as long as there is no waveform distortion due to the signal reflection.

The operating speed of systems on chips (SoC) has gradually increased, so that EMI problems arise for various reasons, including coupling, common-mode noise, increased temperature, etc. Since EMI is generally caused by the large width of the voltage swing, most EMI problems may be solved by lowering the driving voltage applied to the board 101. The EMI due to difference between driving voltages can be calculated by the following equation 1.

P=20*log(V1/V2)[dB] [Equation 1]

For example, as shown in FIG. 1B, the low driver strength generates a width of voltage swing: 1.7V−0.75V=0.95V, and the high driver strength generates a width of voltage swing: 1.85V−0.65V=1.2V, so that there is a width difference in the voltage swing of 1.2V−0.95V=250 mV between the low driver strength and the high driver strength. If V1=1.2V and V2=0.95V are applied to the equation 1, the low driver strength is reduced in the EMI of about 2.5 dB as compared with the high voltage strength. If peak-to-peak voltages are surplus to requirements, it may cause various EMI problems. Thus, the intensity of current is lowered if the waveform is stable, such as a case of the memory inserted in the second memory slot 142, thereby decreasing the unnecessary width of voltage swing.

Accordingly, the low intensity of current (i.e., low driver strength) is used for stable data communication with the memories Memory D2_0 through D2_7 distant from the controller 130. The electronic device 100 is affected only by data input to the memories Memory D2_0 through D2_7 regardless of any signal input to the memories Memory D1_0 through D1_7.

For data communication between the controller 130 and the memory 111 and 112, the controller 130 increases the intensity of current when performing data communication with the close memory slot among the plurality of memory slots 141 and 142 in such a manner that the intensity of current is higher than that for performing the data communication with the distant memory slot. Similarly, the controller 130 decreases the intensity of current when performing the data communication with the distant memory among the plurality of memory slots 141 and 142 in such a manner that the intensity of current is lower than that for performing the data communication with the close memory slot.

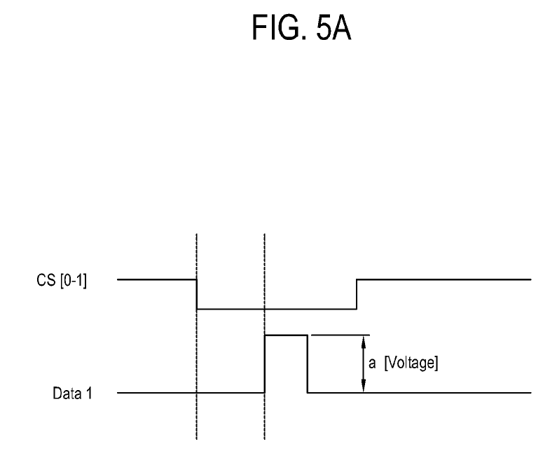

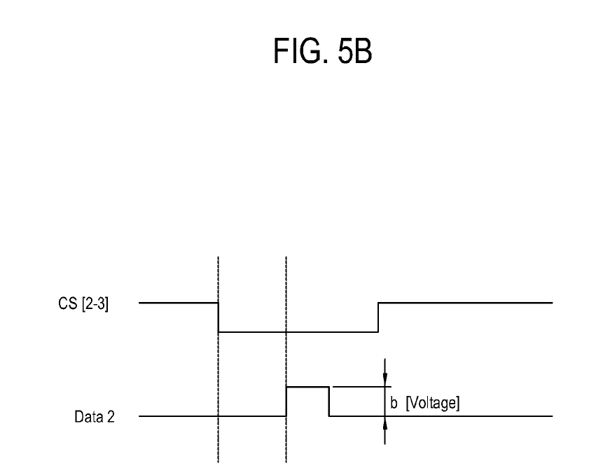

FIGS. 5A and 5B show voltage levels of data signals depending on selected memories according to an embodiment of the present invention. A voltage waveform between the controller 130 and the memories 111 and 112 result from measurements using a device such as an oscilloscope. The level a, b of voltage waveform applied from the controller 130 to the memory 111, 112 varies according to which of the memories 111 and 112 is selected by the chip selection signal. The level a of voltage applied to the memory 111 inserted in the memory slot 141 placed close to the controller 130 (as shown in FIG. 5A) is higher than the level b of voltage applied to the memory 112 inserted in the memory slot 142 placed distant from the controller 130 (as shown in FIG. 5B).

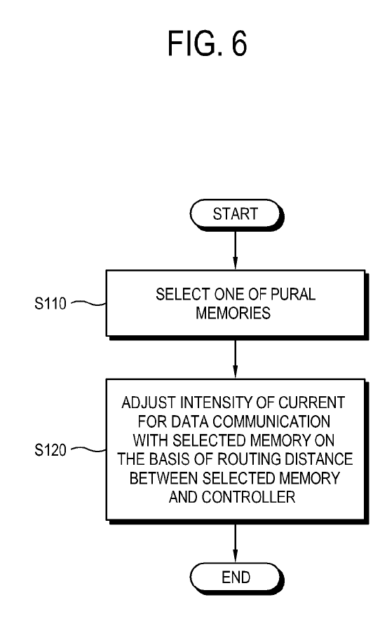

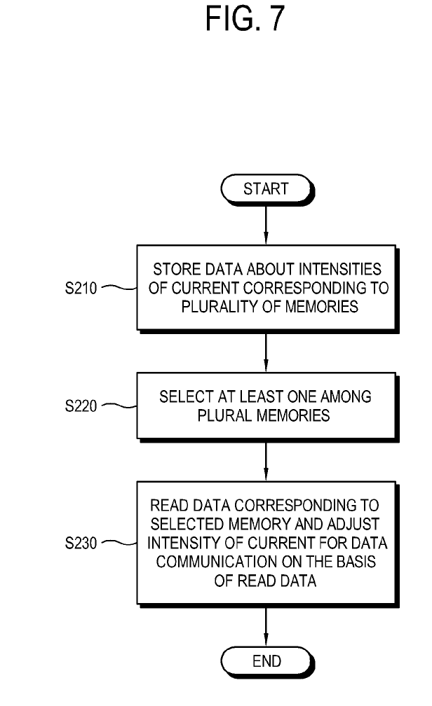

In the electronic device 100 with this configuration, a control process thereof will be described with reference to FIGS. 6 and 7. However, the process described is not limited to the configuration of the electronic device 100; the process may also be applied to other configurations of the electronic device 100.

As shown in FIG. 6, at least one memory among the plurality of memories 111, 112 of the electronic device 100 is selected at operation S110. To select the memory, the controller 130 transmits the chip selection signal to the desired memory.

At operation S120, the controller 130 adjusts the intensity of the current for the data communication with the selected memory based on a distance between the controller 130 and the memory slot in which the selected memory is inserted. At operation S120, the controller 130 increases the intensity of the current when performing the data communication with the close memory slot among the plurality of memory slots 141 and 142 in such a manner that the intensity of current is higher than that for performing the data communication with the distant memory slot. Thus, the level a of the voltage is measured as shown in the voltage waveform of FIG. 5A. Similarly, the controller 130 decreases the intensity of the current when performing the data communication with the distant memory among the plurality of memory slots 141 and 142 in such a manner that the intensity of current is lower than that for performing the data communication with the close memory slot. Thus, the level b of the voltage, lower than that of FIG. 5A, is measured as shown in the voltage waveform of FIG. 5B. Accordingly, it will be appreciated that the measured level of the voltage waveform varies the distance between the controller 130 and the memory slots 141, 142.

As shown in FIG. 7, at operation S210, the controller 130 controls the storage unit 120 to store data about the intensity of current corresponding to the plurality of memories 111, 112. Then, when at least one of the plurality of memories 111, 112 is selected at operation S220, the controller 130 reads the previously stored data corresponding to the selected memory and adjusts the intensity of current for the data communication at operation S230.

As described above, aspects of the present invention provide an electronic device and a control method thereof, in which intensity of current for data communication between a memory and a controller can be adjusted according to routing distances between the memory and the controller so that a closer memory slot and a distant memory slot can be different in a width of voltage swing to thereby stably maintain the quality of a signal. Further, aspects of the present invention provide an electronic device and a control method thereof, which can prevent a malfunction due to increased temperature of a board, radiated emission (EMI), etc. caused by the large width of the voltage swing.

Aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CDs, DVDs, magnetic tapes, floppy disks, and optical data storage devices. Aspects of the present invention may also be embodied as carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although a few embodiments of the present invention have been shown and described, it will be appreciated by those skilled in the art that changes may be made in these embodiments without departing from the principles and spirit of the invention, the scope of which is defined in the claims and their equivalents.

What is claimed is:

1. An electronic device comprising:
a plurality of memories inserted in at least one memory slot provided on a board; and
a controller provided on the board to perform data communication with the plurality of memories and to adjust an intensity of a current for data communication with a memory selected from the plurality of memories based on a distance between the controller and a memory slot in which the selected memory is inserted.

2. The electronic device according to claim 1, wherein the controller increases the intensity of the current when performing data communication with the memory slot in such a manner that the intensity of the current is higher than that for performing the data communication with a more distant memory slot.

3. The electronic device according to claim 1, wherein the controller decreases the intensity of the current when performing the data communication with the memory slot in such a manner that the intensity of the current is lower than that for performing the data communication with a closer memory slot.

4. The electronic device according to claim 1, wherein the controller transmits a chip selection signal to at least one of the plurality of memories.

5. The electronic device according to claim 1, further comprising:
a storage unit to store data about intensities of currents corresponding to the plurality of memories;
wherein the controller reads the previously stored data corresponding to the selected memory and adjusts the intensity of current for the data communication based on the read data.

6. A method of controlling an electronic device comprising a plurality of memories to be inserted in memory slots provided on a board, and a controller to perform data communication with the plurality of memories through the memory slots, the method comprising:
selecting at least one of the plurality of memories; and
adjusting an intensity of a current for data communication with the selected memory based on a distance from a memory slot in which the selected memory is inserted to the controller.

7. The method according to claim 6, wherein the adjusting of the intensity of the current comprises increasing the intensity of the current when performing the data communication with the memory slot in such a manner that the intensity of the current is higher than that for performing the data communication with a more distant memory slot.

8. The method according to claim 6, wherein the adjusting of the intensity of the current comprises decreasing the intensity of the current when performing the data communication with the memory slot in such a manner that the intensity of the current is lower than that for performing the data communication with a closer memory slot.

9. The method according to claim 6, wherein the selecting of at least one of the plurality of memories comprises transmitting a chip selection signal to a desired memory.

10. The method according to claim 6, further comprising:
storing data about the intensities of current corresponding to the plurality of memories;
wherein the adjusting of the intensity of current comprises reading the previously stored data corresponding to the selected memory, and adjusting the intensity of current for the data communication based on the read data.

11. An electronic device comprising:
a controller to communicate with at least one memory of a plurality of memories using a current having an intensity based on a distance between the at least one memory and the controller; and
a storage unit to store information about the current intensity.

12. The electronic device of claim 11, further comprising:
a printed circuit board having the plurality of memories;
wherein the controller and the storage unit are disposed on the printed circuit board.

13. The electronic device of claim 12, further comprising:
a plurality of memory slots arranged on the printed circuit board;
wherein each of the plurality of memories is inserted into a corresponding one of the plurality of memory slots.

14. The electronic device of claim 11, wherein the controller communicates with the at least one memory using a current having an intensity greater than an intensity used to communicate with a memory closer to the controller than the at least one memory.

15. The electronic device of claim 11, wherein the controller communicates with the at least one memory using a current having an intensity less than an intensity used to communicate with a memory further away from the controller than the at least one memory.

16. The electronic device of claim 11, wherein the controller determines the intensity of the current using information on current intensities stored in the storage unit.

17. A method of communicating with a memory selected from a plurality of memories, comprising:
determining a current intensity based on a distance between a controller and the selected memory; and
communicating with the selected memory using a current having the determined current intensity so as to maintain stable communication with the selected memory.

18. The method of claim 17, wherein the determining of the current intensity comprises determining the current intensity to be an intensity greater than a current intensity used to communicate with a memory closer to the controller than the selected memory.

19. The method of claim 17, wherein the determining of the current intensity comprises determining the current intensity to be an intensity less than a current intensity used to communicate with a memory further away from the controller than the selected memory.

20. A computer readable medium comprising instructions that, when executed by an electronic device, cause the electronic device to perform the method of claim 17.

21. The method of claim 17, wherein the determining of the current intensity comprises reading the current intensity corresponding to the selected memory from a storage unit.
